(19) United States
(12) Patent Application Publication
(10) Pub. No.: US 2011/0296805 A1
(43) Pub. Date: Dec. 8, 2011

(54) ELECTRONIC DEVICE AND FILTER UNIT

(75) Inventor: Kazunori KOTANI, Nara-shi (JP)

(73) Assignee: Sanyo Electric Co., Ltd., Osaka (JP)

(21) Appl. No.: 13/150,769

(22) Filed: Jun. 1, 2011

(30) Foreign Application Priority Data
Jun. 8, 2010 (JP) 2010-131288

(51) Int. Cl. B01D 46/42

(52) U.S. Cl. 55/301

(57) ABSTRACT

A cleaner, which automatically cleans an air filter, is coupled to an outer (upstream) side of a partition including an intake port. The air filter is coupled to the intake port through which air is drawn. The partition includes an opening used to electrically connect the cleaner to an inner (downstream) side. A substrate is coupled to the opening 42. A connector connected to the cleaner and a connector connected to an electrical system in a main body are arranged on the substrate. The two connectors are connected by a through hole at a peripheral section of the substrate.

### CROSS-REFERENCE TO RELATED APPLICATIONS

This application is based upon and claims the benefit of priority from prior Japanese Patent Application No. 2010-131288, filed on Jun. 8, 2010, the entire contents of which are incorporated herein by reference.

### BACKGROUND OF THE INVENTION

The present invention relates to an electronic device and a filter unit, and more particularly, to an air filter device that automatically cleans an air filter.

An electronic device, such as a personal computer or a video projector, draws in ambient air and uses the air to cool components. In particular, for a video projector, the air cools a light source lamp, which functions as a light source and becomes hot.

In such an electronic device, an air filter is used to capture dust that is suspended in the drawn in air. However, as time elapses, the air filter clogs as the captured dust accumulates. When the air filter clogs, the amount of air drawn through the air filter decreases. This adversely affects the effect for cooling components. To solve this problem, the air filter is manually cleaned. However, manual cleaning is troublesome. Accordingly, a device that automatically cleans an air filter has been developed.

Japanese Laid-Open Patent Publication No. 2008-65021 describes an example of a video projector including a filter unit that automatically cleans a pre-filter. The video projector, which is an electronic device, includes a housing with an air intake. The filter unit is coupled to the air intake. The filter unit includes an opening to which the pre-filter is coupled. Further, the filter unit includes brushes arranged on opposite sides of the pre-filter to remove dust from the pre-filter. A drive unit is arranged in the housing to move the pre-filter. A connector, which is arranged in a side wall of the housing, connects the filter unit to a main body of the electronic device.

A power line, which supplies power to the filter unit accommodated in the drive unit, and a control line, which provides a control signals to the filter unit, extend from inside the main body of the video projector into the filter unit. In this arrangement, there is no mechanism that effectively prevents dust from entering the opening

FIG. 5 shows a prior art example of a typical filter unit. The filter unit is located in an outer wall of a housing 101, which includes an opening 102. A substrate 103 closes the opening 102. The substrate 103 includes a first surface and a second surface. A copper foil pattern is applied to each surface of the substrate 103. The copper foil pattern on the first surface is connected to a connector in the main body. The copper foil pattern on the second surface is connected to a filter unit connector. A through hole 106 extends between and connects the two copper foil patterns. In this arrangement, ambient air is drawn through the through hole 106 into the electronic device. Thus, dust may enter the electronic device and deteriorate the image quality.

### SUMMARY OF THE INVENTION

One aspect of the present invention is an electronic device provided with a housing including a partition that separates an inner side of the electronic device from an outer side of the electronic device. An intake port is arranged in the partition. Air is drawn through the intake port into the housing. An air filter is coupled to the intake port. The air filter captures dust from the air drawn into the housing. A cleaner is coupled to the partition at the outer side of the housing. The cleaner automatically cleans the air filter. An opening is arranged in the partition. The opening is used to electrically connect the cleaner with an electrical system of the electronic device in the housing. A substrate is coupled to the partition to cover the opening. The substrate includes a first surface, which is exposed toward the outer side of the housing, a second surface, which is exposed toward the inner side of the housing, a first portion, which corresponds to the opening, and a second portion, which extends continuously around the opening. A first connector is mounted on the first surface of the substrate and connected to the cleaner. A second connector is mounted on the second surface of the substrate and connected to the electrical system in the housing. A connection portion is arranged in at least the second portion of the substrate. The connection portion electrically connects the first connector and the second connector and is located outward of the opening.

A further aspect of the present invention is a filter unit provided with a housing including a partition Anintake port is arranged in the partition. Air is drawn through the intake port into the housing. An air filter is coupled to the intake port. The air filter captures dust from the air drawn into the housing. A cleaner is coupled to at an outer side of the housing. The cleaner automatically cleans the air filter. An opening is arranged in the housing. The opening is used to electrically connect the cleaner with an electrical system of an electronic device in the housing. A substrate is coupled to the housing to cover the opening. The substrate includes a first surface, which is exposed toward the outer side of the housing, a second surface, which is exposed toward the inner side of the housing, a first portion, which corresponds to the opening, and a second portion, which extends continuously from the first portion and outward from the opening. A first connector is mounted on the first surface of the substrate and connected to the cleaner. A second connector is mounted on the second surface of the substrate and connected to the electrical system in the housing. A connection portion is arranged in at least the second portion of the substrate. The connection portion electrically connects the first connector and the second connector.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a perspective view showing from below a video projector using a filter unit according to a first embodiment;

FIG. 2 is a block diagram of the video projector shown in FIG. 1;

FIGS. 3(a) and 3(b) show the structure of a substrate of the filter unit in the filter unit of FIG. 1, in which FIG. 3(a) is a plan view showing only the substrate, and FIG. 3(b) is a cross-sectional view showing the substrate and its surrounding;

FIG. 4 is a cross-sectional view showing a substrate and its surrounding in a filter unit according to a second embodiment; and

FIG. 5 shows the structure of a substrate in a video projector of a referential example, in which FIG. 5(a) is a plane view showing only a copper pattern, and FIG. 5(b) is a cross-sectional view showing the substrate and its surrounding.

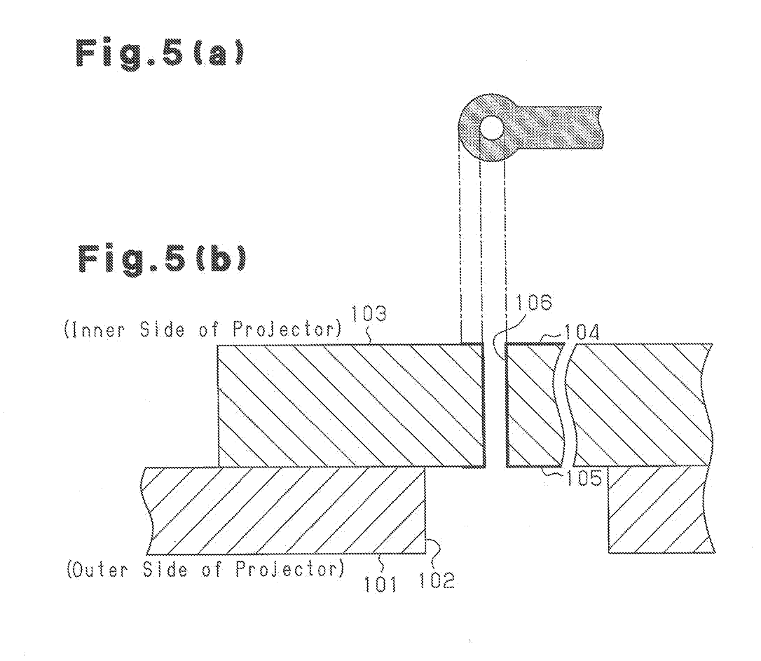

### DETAILED DESCRIPTION OF THE PREFERRED EMBODIMENTS

### First Embodiment

A video projector serving as an electronic device according to a first embodiment of the present invention will now be described with reference to the drawings. In the description hereafter, unless otherwise indicated, the upper, lower, left, right, front, and rear directions are as viewed in each drawing.

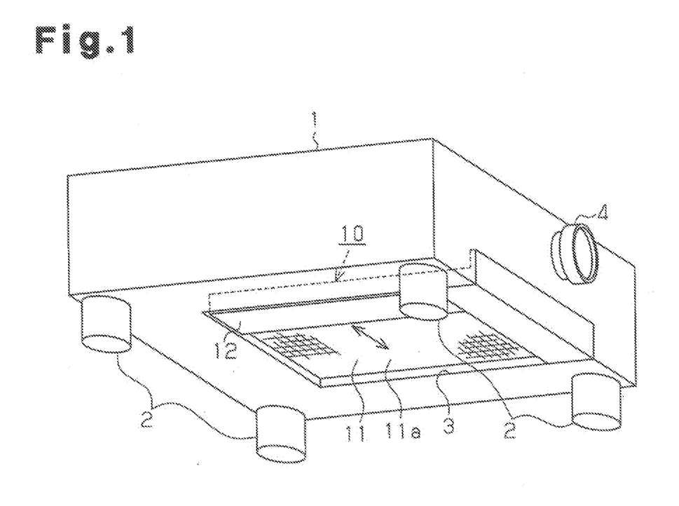

A video projector serving as an electronic device according to a first embodiment is a three-chip liquid crystal display projector and includes a box-shaped shell 1 as shown in the perspective view of FIG. 1. The shell 1 includes a bottom wall with four legs 2 arranged at the corners. Air used for cooling is drawn into the shell 1 from the bottom wall through an air inlet 3. An air filter device is arranged in the air inlet 3.

The air filter device is formed by a filter unit 10, which includes an air filter 11 and equipment for automatically cleaning the air filter 11. The filter unit 10 is coupled to and removed from the shell 1 from a front side at which a projection lens 4 is arranged.

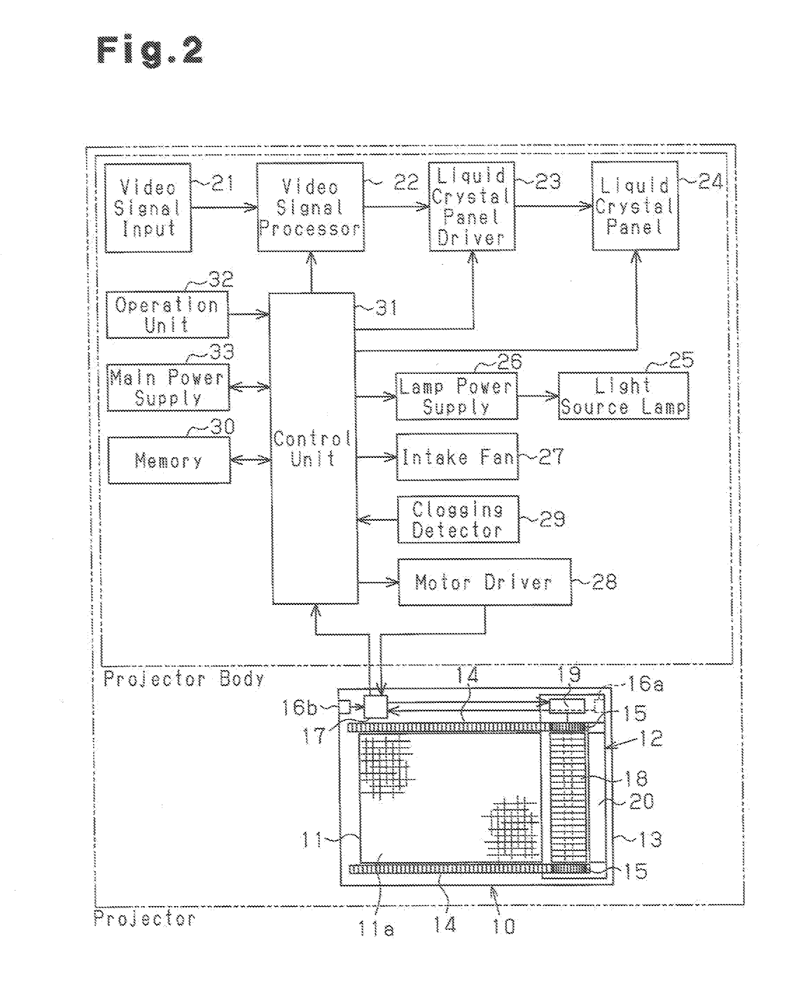

Referring to FIG. 2, the air filter 11 includes a housing 13. An automatic cleaner 12 is arranged on the housing 13. Racks 14 are arranged in front of and behind the air filter 11 on the housing 13. A pinion 15 is engaged with each rack 14. The filter unit 10 further includes a standby position sensor 16a, which detects movement of the automatic cleaner 12, a return position sensor 16b, and a substrate 17, which electrically connects the automatic cleaner 12 to a main body of the video projector.

As shown in FIG. 2, the automatic cleaner 12 includes a rotation brush 18, a motor 19, and a dust box 20. The rotation brush 18 removes dust from the air filter 11. The motor 19 drives the pinions 15 and the rotation brush 18. The dust box 20 collects the dust removed by the rotation brush 18.

The air filter 11 covers the air inlet 3 in the bottom wall of the shell 1. The air filter 11 includes a primary air filter 11a, which is exposed toward the downward area, and a secondary air filter (not shown), which is arranged inward from the primary air filter 11a, that is, at the downstream side of the primary air filter 11a.

The automatic cleaner 12 removes dust from the air filter 11 while moving along the upstream side of the air filter 11. This restores the air intake capability of the air filter 11. The motor 19 drives the automatic cleaner 12. When the motor 19 is driven, the pinions 15 rotate in a state engaged with the racks 14 to move the automatic cleaner 12. The rotation brush 18 is rotated by a gear mechanism (not shown) when the automatic cleaner 12 moves. Accordingly, the rotation brush 18 moves on the air filter 11 as it rotates and thereby removes dust from the air filter 11.

In the state shown in FIG. 2, the automatic cleaner 12 is located at the standby position at which it does not performed cleaning. The automatic cleaner 12 moves leftward as viewed in the drawing to the return position when removing dust from the air filter 11. When the automatic cleaner 12 moves leftward and reaches the return position, the return position sensor 16b is activated. The automatic cleaner 12 is controlled to return to the original standby position based on the information from the return position sensor 16b. The substrate 17 connects the motor 19 to a motor driver 28 (described later) in the projector main body.

The video projector includes a controller, which is shown in the block diagram of FIG. 2.

The video projector includes a video signal input 21, a video signal processor 22, a liquid crystal panel driver 23, a liquid crystal panel 24, a light source lamp 25, and a lamp power supply 26, which are elements for generating an image. The video projector also includes an intake fan 27 related to the cooling system of the optical system, the motor driver 28, a clogging detector 29, and a memory 30. The video projector further includes a control unit 31 for operating the entire device, an operation unit 32, and a main power supply 33.

Video signals from various types of video reproduction devices are input to the video signal input 21. The video signal input to the video signal input 21 undergoes processing, such as A/D conversion and decoding for conversion to a digital signal. Then, the digital signal is output to the video signal processor 22.

In the video signal Processor 22, typical video processing, such as scaling, gamma correction, and luminance correction, is performed on the input video signal. Then, the video signal is output to the liquid crystal panel driver 23.

In the liquid crystal panel driver 23, the video signal input from the video signal processor 22 is converted to a signal format to drive the liquid crystal cells for green light, red light, and blue light. Further, in the liquid crystal panel driver 23, drive pulses for driving the liquid crystal cells for the green light, red light, and blue light are simultaneously generated.

The liquid crystal panel 24 includes the liquid crystal cells for the green light, red light, and blue light. Each liquid crystal cell has a rotation angle that corresponds to the input video signal and produces an image by transmitting light from a separation optical system. The image is displayed on a screen separated from the projection lens 4 by a predetermined distance.

The light source lamp 25 uses a discharge lamp, such as a metal halide lamp or an extra high pressure mercury lamp, as a light emitting body. The light source lamp 25 uses a reflector to emit the illumination light from the light emitting body as collimated light. The light source lamp 25 becomes hot during use and should be cooled. The light generated by the light source lamp 25 is transmitted to the liquid crystal panel through the optical system.

The lamp power supply 26 converts direct current (DC) voltage input from the main power supply 33 to a voltage having a waveform suitable for driving the light source lamp 25. The lamp power supply 26 outputs a voltage having a waveform suitable for each operation when the light source lamp 25 is activated or during normal operation.

The intake fan 27 draws ambient air into the shell 1 to cool hot components. Such components include the light source lamp 25, the liquid crystal panel 24, and the lamp power supply 26.

The motor driver 28 controls the motor 19 of the filter unit 10 when performing an automatic cleaning operation on the air filter 11. When removing dust from the air filter 11, the motor driver 28 drives the motor 19 to move the automatic cleaner 12 a the return position at the left end while rotating the rotation brush 18. When moving to the return position, the motor driver 28 drives the motor 19, based on information from the return position sensor 16b, and returns the automatic cleaner 12 to the original standby position. The automatic cleaner 12 is moved when the pinions 15, which are engaged with the racks 14, are rotated by the motor 19.

The clogging detector 29 includes a flow rate sensor. The clogging detector 29 determines clogging when the output voltage of the flow rate sensor changes. More specifically, the clogging detector 29 compares a change in the output voltage with a voltage threshold value stored in the memory 30 to determine whether or not clogging has occurred.

The memory 30 includes a ROM memory and a non-volatile RAM memory. The memory 30 stores control programs for the entire video projector, information (flag) necessary for determining the clogging state of the air filter 11, and programs of a cleaning operation sequence for controlling the filter unit 10. The filter unit 10 is controlled when the control unit 31 is activated in accordance with the information and programs stored in the memory 30.

The control unit 31 exchanges signals with each unit in the video projector to control operation of the entire video projector. The control unit 31 transmits a necessary control signal to the motor driver 28 while receiving information from the standby position sensor 16a and the return position sensor 16b when driving the filter unit 10.

The user uses the operation unit 32 to operate the video projector. The operation unit 32 includes parts operated by the user, such as an operation switch, a key, a remote controller, or an external computer. The information input from the operation unit 32 is processed in the control unit 31, and operation contents contained in the information is transmitted from the control unit 31 to each unit for execution.

The main power supply 33 is supplied with alternating current (AC) power from the external power supply and incorporates an AC/DC converter. The main power supply 33 generates stable DC voltage by performing processes such as transformation, rectification, and smoothing on the AC power in the AC/DC converter and supplies the generated DC voltage to each unit of the video projector.

The operation of the air filter device will now be described.

During operation of the air filter device, when the clogging detector 29 detects clogging of the air filter, the air filter device is controlled to perform an automatic cleaning operation on the filter unit 10.

In response to a command for performing an automatic cleaning operation, the motor 19 of the automatic cleaner 12 is driven. This drives the pinions 15, which are engaged with the racks 14, and moves the automatic cleaner 12 toward the left from the standby position shown in FIG. 2. At the same time, the rotation brush 18 is rotated on the surface of the air filter 11 to remove dust from the air filter 11. The removed dust is collected in the dust box 20. When the automatic cleaner 12 reaches the return position at the left end of the air filter 11, the return position sensor 16b detects the automatic cleaner 12. Then, the motor 19 produces reverse rotation to return the automatic cleaner 12 to the standby position. This automatically removes dust from the air filter 11.

A structure for electrically connecting the automatic cleaner 12 to the main body of the video projector will now be described.

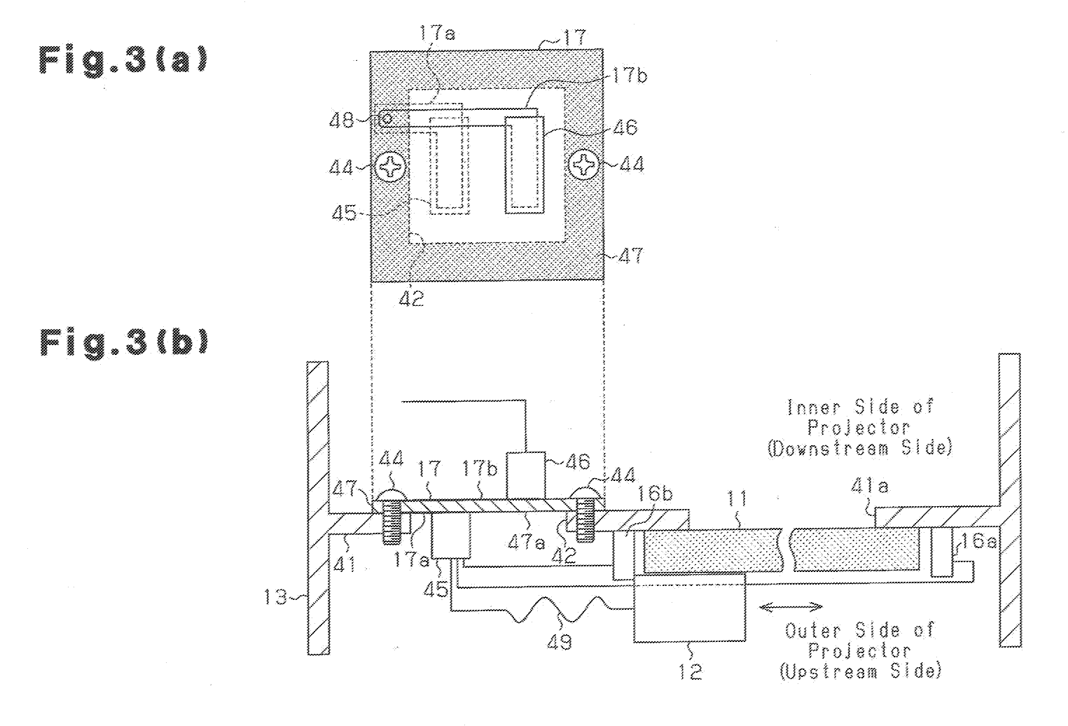

As shown in FIG. 3(b), part of the housing 13 of the filter unit 10 forms a partition 41, which separates the upstream side and downstream side of the air filter 11. In other words, the partition 41 separates the outer side and inner side of the video projector. The partition 41 includes an intake port 41a through which air is drawn. The air filter 11 is arranged in correspondence with the intake port 41a. FIG. 3(b) shows a state in which the automatic cleaner 12 is moved to the return position at the left end of the air filter 11 shown in FIG. 2. The return position sensor 16b detects the automatic cleaner 12 at this position.

The partition 41 includes an opening 42, which is used to electrically connect the automatic cleaner 12 to an electrical system in the main body of the video projector. The substrate 17 is fastened by screws 44 to the partition 41 around the opening 42. A connector 45 is mounted on the outer side, or upstream side, of the substrate 17. The connector 45 is also connected to the automatic cleaner 12, standby position sensor 16a, and return position sensor 16b, which are located outside the main body of the video projector. A connector 46 is mounted on the inner side, or downstream side, of the substrate 17 and connected to the electrical system, which is located inside the main body of the video projector. Copper foil patterns 17a and 17b respectively connected to the connectors 45 and 46 are applied to the outer surface and inner surface of the substrate 17. The outer and inner copper foil patterns 17a and 17b extend to a portion 47, which is overlapped with the wall defining the opening 42 and extends around the periphery of the opening 42. The portion 47 includes a through hole 48 extending between and connecting the copper foil patterns 17a and 17b. As shown in FIG. 3(b), a flexible wiring substrate 49 connects the connector 45 and the cleaner 12.

The video projector including the filter unit of the present embodiment has the advantages described below.

(1) The portion 47, which is overlapped with the wall defining the opening 42 and extends along the periphery of the opening 42, connects the outer (upstream) connector 45 and inner (downstream) connector 46. Since the connection is in the portion 47, ambient air does not enter the video projector bypassing the air filter 11. This prevents dust from entering the video projector.

(2) More specifically, the through hole 48 is formed in the portion 47, which is overlapped with the wall defining the opening 42 in the partition 41 and extends around the periphery of the opening 42. The through hole 48 connects the copper foil patterns 17a and 17b, which are arranged on the surfaces of the substrate 17. Accordingly, the through hole 48 is covered by the partition 41. This prevents ambient air that bypasses the air filter 11 from entering the video projector.

### Second Embodiment

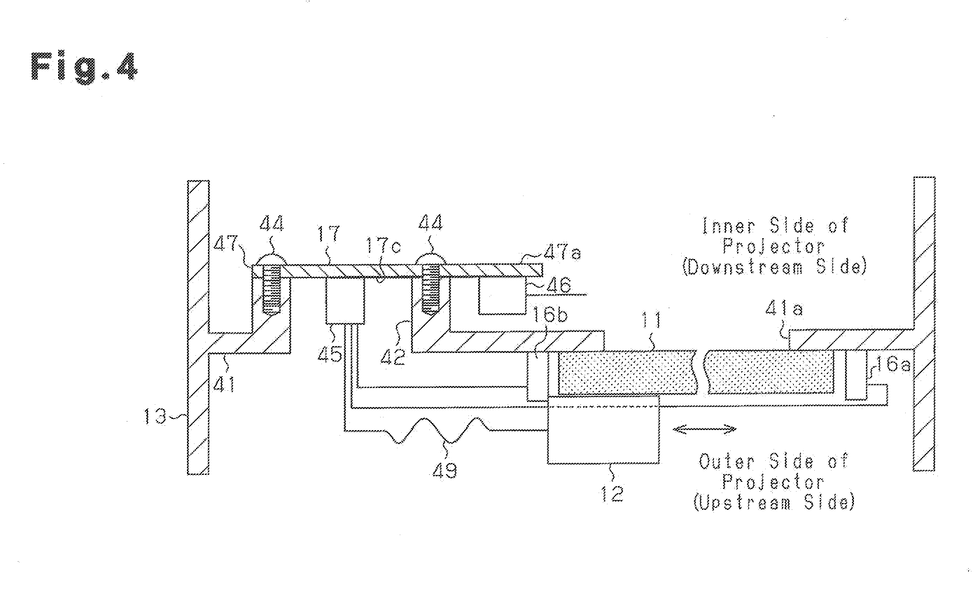

A second embodiment of a video projector will now be described with reference to FIG. 4. The video projector of the second embodiment differs from that of the first embodiment in the structure around the substrate. The structure around the substrate will mainly be described below. Like or same reference numerals are given to those components that are the same as the corresponding components of the first embodiment. Such components will not be described,

As shown in FIG. 4, in the video projector of the second embodiment, the substrate 17 extends from a portion overlapped with the opening 42. The inner (downstream) connector 46 is arranged on an extension 47a of the substrate 17 at the same side as the outer (upstream) connector 45. The outer (upstream) connector 45 is arranged on the substrate 17 at a portion located in the opening 42. Accordingly, the outer connector 45 and the inner connector 46 are located in areas divided by the wall that defines the opening 42. The inner (downstream) connector 45 and the outer (upstream) connector 46 are connected by a copper foil pattern 17c, which extends from the outer connector 45 to the connector 46 on the extension 47a.

In addition to advantage (1) of the first embodiment, the video projector has the following advantage.

(3) The inner (downstream) connector 45 and the outer (upstream) connector 46 are arranged on the same side of the substrate 17, which is the outer side of the video projector. Thus, the substrate 17 does not need the through hole 48. Accordingly, bypassing air does not enter the video projector through the through hole 48.

It should he apparent to those skilled in the art that the present invention may be embodied in many other specific forms without departing from the spirit or scope of the invention. Particularly, it should be understood that the present invention may be embodied in the following forms.

In the first embodiment, the through hole 48 is formed in the portion 47, in which the substrate 17 and the partition 41 is overlapped. Instead, the through hole 48 may be formed in an extension 47a.

In the video projectors of the above embodiments, the filter unit 10 is used as the air filter device. However, an air filter device integrally incorporated in the video projector may be used in lieu of the filter unit 10.

In such a video projector that integrally incorporates the air filter device, the partition 41, which separates the outer side and inner side of the video projector may be formed in a housing, for example, the shell 1, of the video projector.

In the embodiments described below, the video projector is exemplified as the electronic device. However, the electronic device is not limited in such a manner and may another type of electronic device, such as a large-scale computer or a personal computer.

The present examples and embodiments are to be considered as illustrative and not restrictive, and the invention is not to be limited to the details given herein, but may be modified within the scope and equivalence of the appended claims.

1. An electronic device comprising:
a housing including a partition that separates an inner side of the electronic device from an outer side of the electronic device;
an intake port arranged in the partition, wherein air is drawn through the intake port into the housing;
an air filter coupled to the intake port, wherein the air filter captures dust from the air drawn into the housing;
a cleaner coupled to the partition at the outer side of the housing, wherein the cleaner automatically cleans the air filter;
an opening arranged in the partition, wherein the opening is used to electrically connect the cleaner with an electrical system of the electronic device in the housing;
a substrate coupled to the partition to cover the opening, wherein the substrate includes a first surface, which is exposed toward the outer side of the housing, a second surface, which is exposed toward the inner side of the housing, a first portion, which corresponds to the opening, and a second portion, which extends continuously from the first portion and outward from the opening;
a first connector mounted on the first surface of the substrate and connected to the cleaner;
a second connector mounted on the second surface of the substrate and connected to the electrical system in the housing; and
a connection portion arranged in at least the second portion of the substrate, wherein the connection portion electrically connects the first connector and the second connector and is located outward of the opening.

2. The electronic device according to claim 1, wherein the connection portion includes a through hole extending through the substrate in the second portion, wherein the through hole and electrically connects the first connector and the second connector.

3. The electronic device according to claim 1, wherein
the partition includes a wall extending from the partition around the opening in a direction orthogonal to the partition,
the second portion extends beyond the wall outward from the opening, and
the second connector is arranged adjacent to the wall on the first surface of the substrate.

4. A filter unit comprising:
a housing including a partition;
an intake port arranged in the partition, wherein air is drawn through the intake port into the housing;
an air filter coupled to the intake port, wherein the air filter captures dust from the air drawn into the housing;
a cleaner coupled to at an outer side of the housing, wherein the cleaner automatically cleans the air filter;
an opening arranged in the housing, wherein the opening is used to electrically connect the cleaner with an electrical system of an electronic device in the housing;
a substrate coupled to the housing to cover the opening, wherein the substrate includes a first surface, which is exposed toward the outer side of the housing, a second surface, which is exposed toward the inner side of the housing, a first portion, which corresponds to the opening, and a second portion, which extends continuously from the first portion and outward from the opening;
a first connector mounted on the first surface of the substrate and connected to the cleaner;
a second connector mounted on the second surface of the substrate and connected to the electrical system in the housing; and
a connection portion arranged in at least the second portion of the substrate, wherein the connection portion electrically connects the first connector and the second connector.

5. The filter unit according to claim 4, wherein the connection portion includes a through hole extending through the substrate in the second portion, and the through hole electrically connects the first connector and the second connector.

6. The filter unit according to claim 4, wherein
the partition includes a wall extending from the partition around the opening in a direction orthogonal to the partition,
the second portion extends beyond the wall outward from the opening, and
the second connector is arranged adjacent to the wall on the first surface of the substrate.
